(19) United States
(12) Patent Application Publication
(10) Pub. No.: US 2012/0143522 A1
(43) Pub. Date: Jun. 7, 2012

(54) Integrated Solution for Interpretation and Visualization of RTCM and DTS Fiber Sensing Data

(75) Inventors: Jianfeng Chen, Pearland, TX (US); Xudong Yang, Katy, TX (US)

(73) Assignee: BAKER HUGHES INCORPORATED, Houston, TX (US)

(21) Appl. No.: 12/959,781

(22) Filed: Dec. 3, 2010

(51) Int. Cl. G06F 19/00

(52) U.S. Cl. 702/42

(57) ABSTRACT

A method, apparatus and computer-readable medium for determining an effect of an event on a parameter of a member is disclosed. A plurality of strain measurements are obtained at a plurality of times, wherein each strain measurement corresponding to a sensor located at the member. A temperature correction is applied to the plurality of strain measurements obtained at each of the plurality of times. The parameter is obtained from the plurality of temperature-corrected strain measurements at each of the plurality of times, and the effect of the event on the parameter is determined from the time-correlated parameters.

### CROSS REFERENCE TO RELATED APPLICATIONS

The present application is related to Attorney Docket No. PRO4-49331-US, filed Dec. 3, 2010, Attorney Docket No. PRO4-49330-US, filed Dec. 3, 2010, Attorney Docket No. PRO4-49332-US, filed Dec. 3, 2010, Attorney Docket No. PRO4-50985-US, filed Dec. 3, 2010, and Attorney Docket No. PRO4-51016-US, filed Dec. 3, 2010, the contents of which are hereby incorporated herein by reference in their entirety.

### BACKGROUND OF THE DISCLOSURE

1. Field of the Disclosure

The present application is related to determining deformations of tubulars and determining stresses of tubulars in a wellbore.

2. Description of the Related Art

Tubulars are used in many stages of oil exploration and production, such as drilling operations and well completions and wireline logging operations. These tubulars can encounter a large amount of stress, due to compaction, fault movement or subsidence, for example, which can lead to tubular damage or even to well failure. Well failures impact both revenue generation and operation costs for oil and gas production companies. These failures can result in millions of dollars lost in repairing and replacing the wells. Therefore, it is of value to monitor wells to understand the mechanisms of the failures. The present disclosure provides an integrated method for visualizing and interpreting strains on a tubular downhole.

### SUMMARY OF THE DISCLOSURE

In one aspect, the present disclosure provides a determining an effect of an event on a parameter of a member, the method including: obtaining a plurality of strain measurements at a plurality of times, each strain measurement corresponding to a sensor located at the member; applying a temperature correction to the plurality of strain measurements obtained at each of the plurality of times; obtaining the parameter from the plurality of temperature-corrected strain measurements at each of the plurality of times; and determining the effect of the event on the parameter from the time-correlated parameters.

In another aspect, the present disclosure provides an apparatus for determining an effect of an event on a parameter of a member, the apparatus including a plurality of sensors located at the member; a device configured to obtain a plurality of strain measurements from the plurality of sensors at a plurality of times, wherein each strain measurement corresponding to a sensor from the plurality of sensors; and a processor configured to: apply a temperature correction to the plurality of strain measurements obtained at each of the plurality of times, obtain the parameter from the plurality of temperature-corrected strain measurements at each of the plurality of times, and determine the effect of the event on the parameter from the time-correlated parameters.

In another aspect, the present disclosure provides a computer-readable medium having instructions thereon which when read by a processor enable the processor to perform a method, the method including obtaining a plurality of strain measurements at a plurality of times, each strain measurement corresponding to a sensor located at the member; applying a temperature correction to the plurality of strain measurements obtained at each of the plurality of times; obtaining a parameter from the plurality of temperature-corrected strain measurements at each of the plurality of times; and determining an effect of an event on the parameter from the time-correlated parameters

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 shows an exemplary embodiment of a system for determining a deformation of a tubular including temperature effects in on a tubular section disposed in a wellbore;

FIG. 2 shows an exemplary set of data obtained from a tubular under an applied force using the system of FIG. 1;

FIG. 3 shows a frequency spectrum of the exemplary dataset of FIG. 2;

FIG. 4 shows separated strain components in the spatial domain obtained from the exemplary frequency spectrum of FIG. 3;

FIGS. 5A and B show a bending strain data on a tubular before and after calibration;

FIG. 6 shows an illustrative system for mapping gratings from a location in a fiber optic cable to a particular location on the tubular;

FIG. 7 illustrates a step using in mapping data from a fiber location to a location on a tubular surface in an exemplary embodiment of the present disclosure;

FIGS. 8A and 8B show exemplary strain maps before and after application of the the exemplary mapping of FIGS. 6 and 7;

FIG. 9A illustrates an exemplary gridding system for strain interpolation of strains from a fiber optic cable wrapped along the surface of a tubular;

FIG. 9B shows a three-dimensional image with surface color representing the interpolated strains on the exemplary tubular of FIG. 9A;

FIGS. 10A-B show top and side views of a tubular undergoing a bending deformation;

FIGS. 11A-B show the various parameters related to cross-sectional deformations;

FIGS. 12A-D illustrates an exemplary method of constructing a three-dimensional image of a tubular with applied deformations;

FIG. 13 shows an exemplary interactive display for visualization and interpretation of strains on a tubular; and

FIG. 14 shows a flowchart of the exemplary method for obtaining various aspects of the exemplary three-dimensional display of FIG. 13.

### DETAILED DESCRIPTION OF THE DISCLOSURE

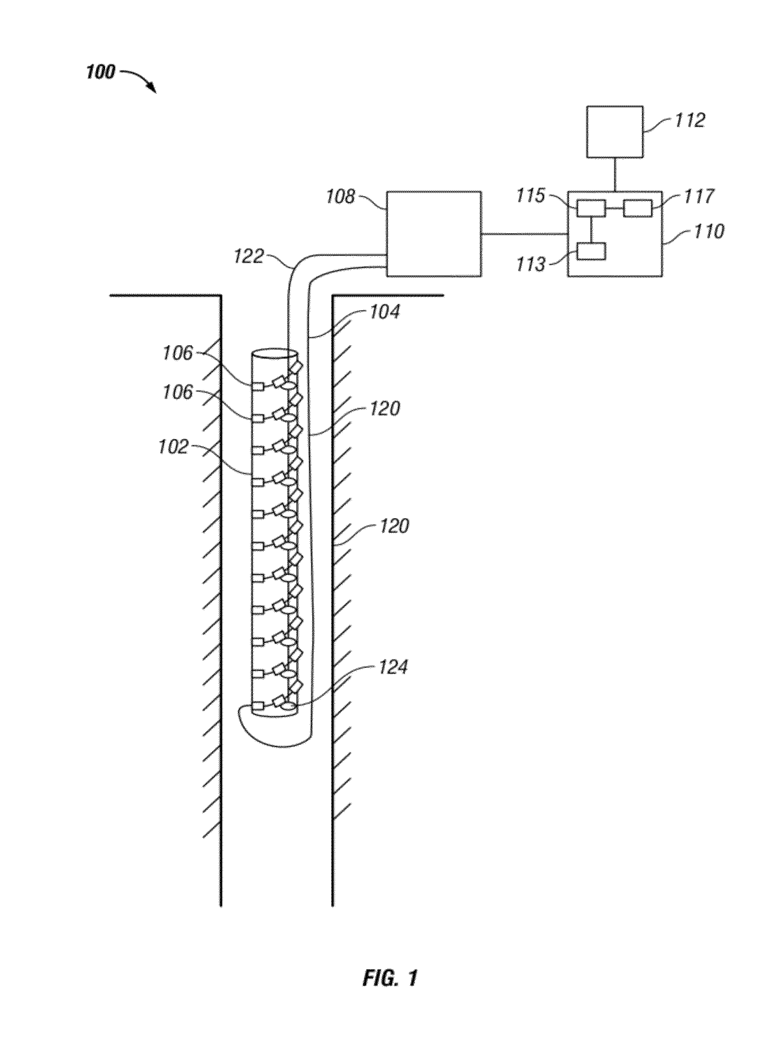

FIG. 1 shows an exemplary embodiment of a system 100 for determining a deformation of a tubular 102 disposed in a wellbore 120. The tubular may be any tubular typically used in a wellbore, such as a well casing or a drilling tubular, for example. When under an applied force, the tubular generally undergoes a variety of deformations such as a bending deformation and cross-sectional deformations. The system 100 includes an optical fiber or fiber optic cable 104 wrapped around the tubular 102. The fiber optic cable has a plurality of optical sensors, such as gratings or Fiber Bragg Gratings (FBGs) 106, along its length for detecting strains at a plurality of locations of the tubular. The FBGs are spatially distributed along the optical fiber 104 at a typical separation distance of a few centimeters. The optical fiber 104 is wrapped at a wrapping angle such that any strain experienced at the tubular can be effectively transferred to the fiber. The smaller the wrapping angle, the more accurate information that can be obtained on the bending and cross-sectional deformations. However, smaller wrapping angles typically require more gratings and thus more optical fiber. A typical wrapping angle is between 20° and 60° and allows for monitoring of strains in both axial and radial directions.

Each sensor or FBG 106 is assigned a number (grating number) indicating its position along the optical fiber. An end of the fiber optic cable is coupled to a sensing unit 108 typically at a surface location that in one aspect obtains a measurement from each of the FBGs to determine a wavelength shift or strain at each of the FBGs. In general, the sensing unit 108 reads the plurality of gratings simultaneously using, for example, frequency divisional multiplexing. Sensing unit 108 is coupled to a surface control unit 110 and in one aspect transmits the measured wavelength shifts to the surface control unit. In one aspect, the surface control unit 110 receives and processes the measured wavelength shifts from the sensing unit 108 to obtain a result, such as a three-dimensional image of a tubular deformation, using the methods disclosed herein. A typical surface control unit 110 includes a computer or processor 113 for performing the exemplary methods disclosed herein, at least one memory 115 for storing programs and data, and a recording medium 117 for recording and storing data and results obtained using the exemplary methods disclosed herein. The surface control unit 110 may output the result to various devices, such as display 112 or to the suitable recording medium 117.

A Fiber Bragg Grating such as FBG 106 typically operates by reflecting light of a selected wavelength. A Fiber Bragg Grating is typically a section of an optical fiber in which the refractive index has been altered into a plurality of regions of higher and lower refractive index which alternate periodically. The periodic distance between the regions of higher refractive index is generally on the order of wavelengths of light and is known as the grating period, D. Typically, light enters the FBG from one end of the fiber and a selected wavelength of light is reflected backwards at the FBG at a wavelength that is related to the grating period D by the following:

λ_{B}=2nD Eq. (1)

where λ_{B} is the wavelength of the reflected light and is known as the Bragg wavelength, n is the refractive index of the optical fiber, and D is the grating period. The FBG is transparent at other wavelengths of light, for all intents and purposes.

As seen with respect to Eq. (1), when D increases, the Bragg wavelength increases. Similarly when D decreases, the Bragg wavelength decreases. Typically, D increases or decrease due to a strain on the FBG. Because of this, an FBG is often attached to an object so that the strains on the object transfer to the FBG to affect the grating period D to thereby produce a wavelength shift that is indicative of the strain. The wavelength shift is then measured.

In various methods employing the measurements from the fiber optic gratings, the strain measurements are used to understand deformations on the tubular. In one exemplary method, known as Real Time Compaction Monitoring (RTCM), these strain measurements are used to obtain deformation modes which can be used to create visual images of the strains on the tubular. In order to accomplish this, various calibrations and corrections are used to obtain a representative strain reading. These can include determining grating positions, wrap angles, tubular diameter corrections, fiber location mapping and temperature corrections.

A tubular undergoing a general deformation experiences one or more deformation modes. Each deformation mode, in turn, has an associated spatial frequency related to the strains obtained at the plurality of FBGs and which can be seen by creating plotting the wavelength shifts Δλ obtained at the plurality of FBGs against the grating numbers of the FBGs to obtain a dataset of the deformation. In an exemplary embodiment, deformation mode of a tubular may be a fundamental deformation mode such as compression/extension, bending, ovalization, triangularization, and rectangularization. The methods disclosed herein are not limited to these particular modes of deformation and can be applied to higher-order modes of deformation.

The compression/extension deformation mode occurs when a tubular experiences a compressive or tensile force applied in the axial direction. Such a force affects both the tubular axis and the circumference of the tubular. For example, as the tubular is shortened along the axial direction under a compressive force, the circumference expands outward to accommodate. As the tubular is lengthened along the axial direction under a tensile force, the circumference constricts inward to accommodate. Since strain is equal along the tubular, the wavelength shift measured at each FBG on the tubular is substantially the same and a substantially horizontal line is shown on corresponding graphs of Δλ vs. grating number.

The bending mode of deformation occurs when an external force is applied perpendicular to the axial direction of a tubular. The tubular is compressed at the side of application of the applied force and is in tension along the side away from the applied force. Therefore, FBGs along the compressed side experience a negative wavelength shift Δλ and FBGs near side in tension experience a positive Δλ. When Δλ is plotted against grating number, the wavelength shift from the bending mode forms a sinusoidal wave having a given (spatial) wavelength that is the length of a wrap of the fiber around the tubular. The spatial frequency of the bending mode is referred to herein as the characteristic frequency of the system.

The other deformation modes (i.e., ovalization, rectangularization and triangularization), often referred to as cross-sectional deformations since they lead to changes in the shape of the cross-section, have spatial frequencies in graphs of Δλ vs. grating number that are related to the characteristic frequency of bending. A typical ovalization deformation mode may occur when two external forces are symmetrically applied perpendicular to the axis of a tubular. In a graph of Δλ vs. grating number, an ovalization mode forms a sinusoidal wave with a frequency that is double the characteristic frequency of the bending deformation. The triangularization deformation mode occurs when three external forces are applied perpendicular to the axis of a tubular along a three-fold symmetry. In a graph of Δλ vs. grating number, the triangularization mode forms a sinusoidal wave with a frequency that is three times the characteristic frequency of the bending deformation. A rectangularization deformation occurs when four external forces are applied perpendicular to the axis of the tubular in a four-fold symmetry. In a graph of Δλ vs. grating number, the rectangularization mode forms a sinusoidal wave with a frequency that is four times the characteristic frequency. Although not discussed herein, higher modes of deformation due to symmetrical applied forces having 5-fold symmetry, 6-fold symmetry and onwards can occur and may be addressed using the methods described herein.

In one embodiment, a tubular strain map may be obtained by separating the fundamental deformation modes from the original dataset and using the separated deformation modes to create a visual image of the strain on the tubular. Methods for determining these deformation modes, determining an overall strain map of the tubular and created an image of the tubular are summarized below and are also discussed in detail in Attorney Docket No. PRO4-49331-US, Attorney Docket No. PRO4-49330-US, and Attorney Docket No. PRO4-49332-US, the contents of which are incorporated herein by reference in their entirety.

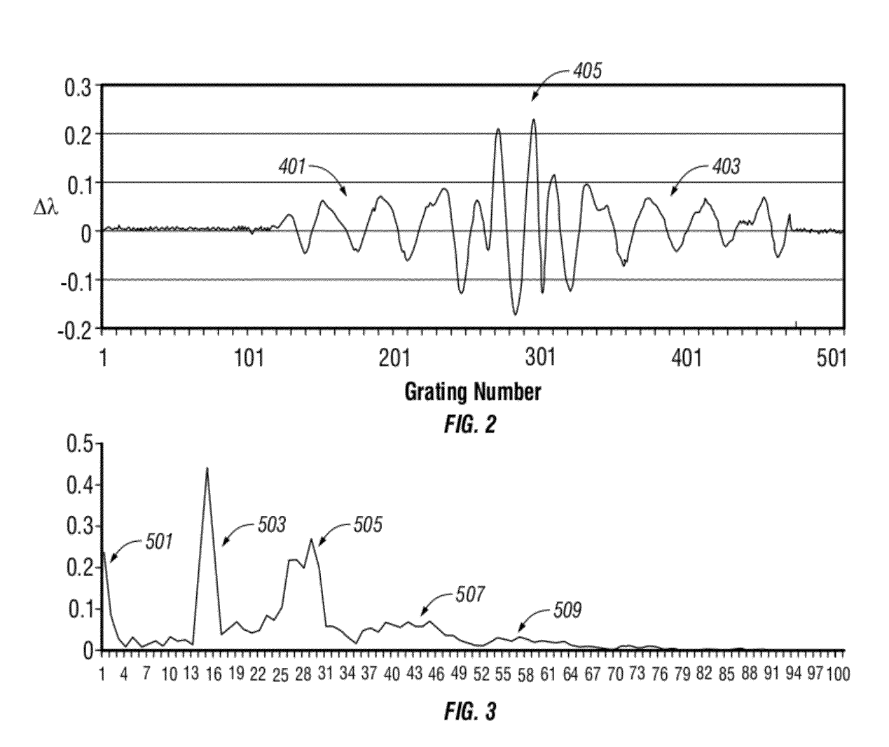

A general deformation of tubular gives rise to a dataset which may displayed as a curve on a graph of wavelength shift against the FBG grating number. An exemplary graph of wavelength shift vs. grating number is shown in FIG. 2. The grating number of each FBG is shown along the abscissa and the change of wavelength Δλ is plotted along the ordinate. The graph displays some regions 201 and 203 which display primarily a single characteristic frequency, which in this case indicates a dominant bending mode at those FBGs and region 205 in which the frequency is double the characteristic frequency which indicates at least an ovalization mode of deformation in addition to the bending mode.

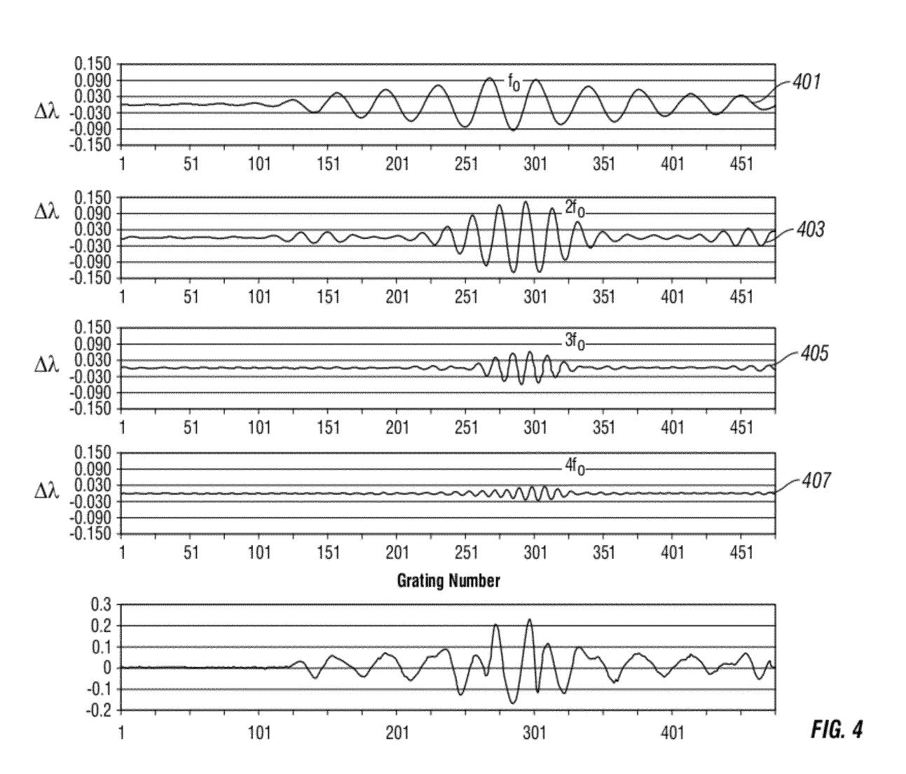

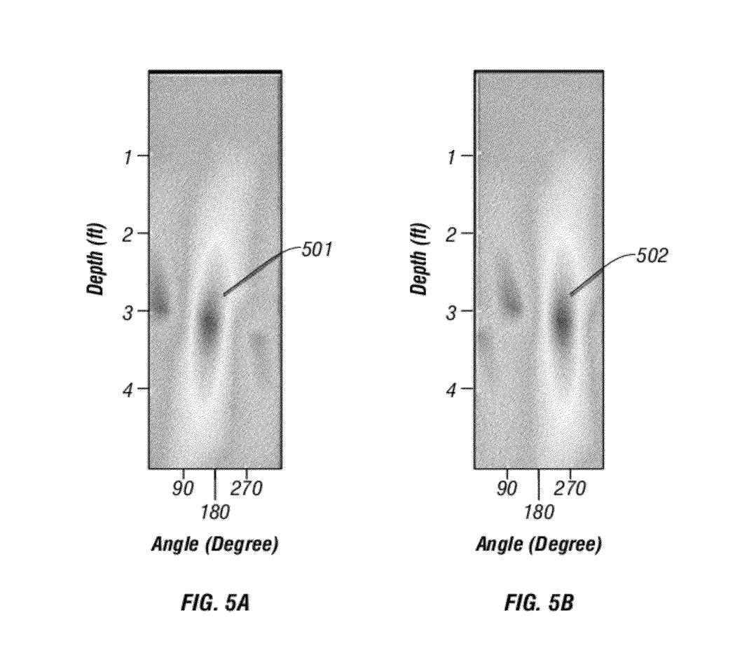

This exemplary curve may be decomposed into a number of curves corresponding to a deformation mode using spectral decomposition for example. FIG. 3 shows a frequency spectrum of the exemplary dataset of FIG. 2. The frequency spectrum is obtained using a transform into a frequency space, such as a Discrete Fast Fourier Transform (DFFT), but any suitable method for obtaining a frequency spectrum may be used. The spectrum shows several peaks, each peak corresponding to a separate deformation mode such as compression/tension 301, bending 303, ovalization 305, triangularization 307, and rectangularization 309. These peaks may be separated using for example an adjustable bandpass filter that is adaptable to select a peak of the spectrum. Applying an inverse transform on the separated peaks therefore yields separate graphs of wavelength shift vs. grating number which correspond to each of the deformation modes. Exemplary deformation modes related to FIG. 2 are shown in FIG. 4. Bending 401, ovalization 402, triangularization 405 and rectangularization 407 modes are separately shown.

The exemplary methods for obtaining deformation modes discussed above are affected by various conditions that may produce an error in measurements and thus in results. Some of these conditions include temperature, noise, errors in grating location etc. These conditions are addressed using the exemplary methods discussed below.

In one aspect, grating location is determined using calibration methods, typically performed prior to deployment of the tubular downhole. In an exemplary calibration, a location of a selected grating on the tubular may be determined by heating only the selected grating with a heating instrument and observing a corresponding wavelength shift with respect to the selected grating at the sensing unit 108. This heating can be done for any number of gratings to determine location of the grating. Such obtained data provide accurate information on the average number of gratings in each wrap, as well as actual the gratings in each individual wrap. This data can therefore correct for inaccuracies in the tubular diameter and the wrap angle. In addition, this calibration can be used to determine a selected first grating of the tubular. Gratings prior to the selected first grating are typically on a lead portion of the fiber optic cable and provide measurements unrelated to the strain on the tubular. Therefore, determining a selected first grating enables separating the measurements from unrelated gratings from measurements related to the strain on the tubular.

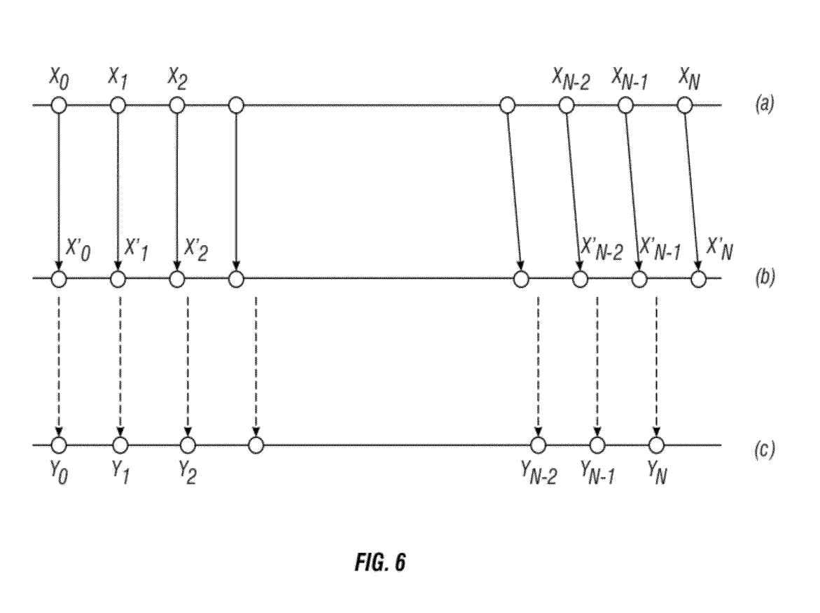

In another embodiment, a bending calibration may be performed. Under an applied bending force, the tubular bends along a known azimuth deformation angle over the entire tubular. Obtaining bending data provides information on average number of gratings in each wrap and identification of the grating in each individual wrap. In addition, one may visually correct data using a calibrated 2D strain map of the bending data, such as shown in FIGS. 5A and B. FIGS. 5A and B show a bending strain data on a tubular before and after calibration. FIG. 5A shows non-perpendicular strain bands 501. When the system is calibrated as in FIG. 5B, the strain bands 502 of the 2D map are perpendicular to the y-axis.

The location of a grating on the tubular is determined by wrap angle, the outer-diameter of the tubular and inter-grating spacing. Systematic errors in any of these are accumulative, such that an error on the location of a particular grating contributes to errors on all subsequent gratings. For an exemplary wrapped fiber having total 400 Bragg gratings and with 40 gratings in each wrap, the error on azimuth angle for the last wrap may be as big as 36°, even if the systematic error is only 1%. To meaningfully determine the azimuth angle, the location of the fiber on the tubular is allocated according to the exemplary methods described herein.

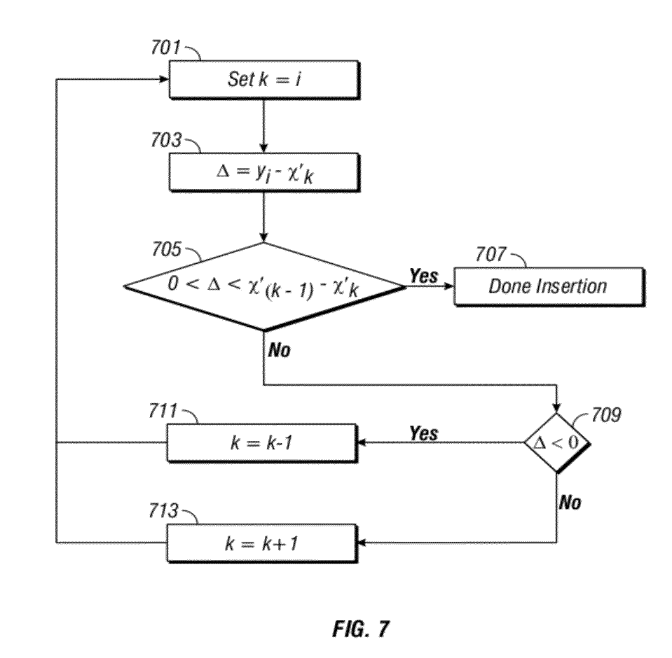

FIG. 6 shows an illustrative system for mapping gratings from a location in a fiber optic cable to a particular location on the tubular. Bragg grating locations are in the fiber are indicated by dots labeled (x₁, x₂, . . . , x_{N}) and are referred to as fiber locations. The tubular surface locations are indicated by dots (y₁, y₂, . . . , y_{N}) and are the determined tubular locations for later use in numerical processing and surface construction. The tubular locations are generally selected such that an integer number of gratings are evenly distributed in each wrap and along the pipe surface.

In one embodiment, two steps are used in order to determine a tubular location from the fiber location. In a first step, corrections are made for inaccuracies in tubular diameter or wrap angle using, for instance, the exemplary calibration methods described above. If (x₀, x₁, . . . , x_{N}) are respectively the measured fiber locations in the sensing fiber, each grating space measured is multiplied by a factor k that is determined either from a heating string correction data or is obtained by taking k as adjustable parameter to align bending correction strain. This therefore maps the fiber location (x₀, x₁, . . . , x_{N}) to an intermediate calculated location (x′₀, x′₁, . . . , x′_{N}).

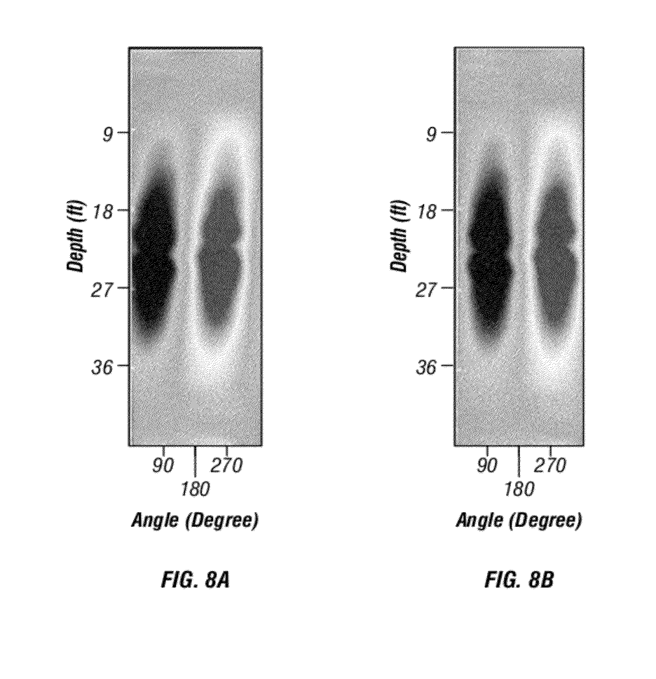

A second step is to map the data to corrected locations onto the tubular surface location as shown in the exemplary insertion method of FIG. 7. In Box 701, the index k for the grating location is set to the index i for the surface location. In Box 703 a difference Δ is determined between the grating location and the calculated location. In Box 705, if this difference is less than a spacing between adjacent calculated locations, the insertion process is concluded (Box 707). Otherwise, in Box 709, it is determined whether Δ is negative. If the Δ<0, then the index k of the grating location is decreased by one and the method repeats from Box 701. If the Δ≧0, then the index k of the grating location is increase by one and the method repeats from Box 701.

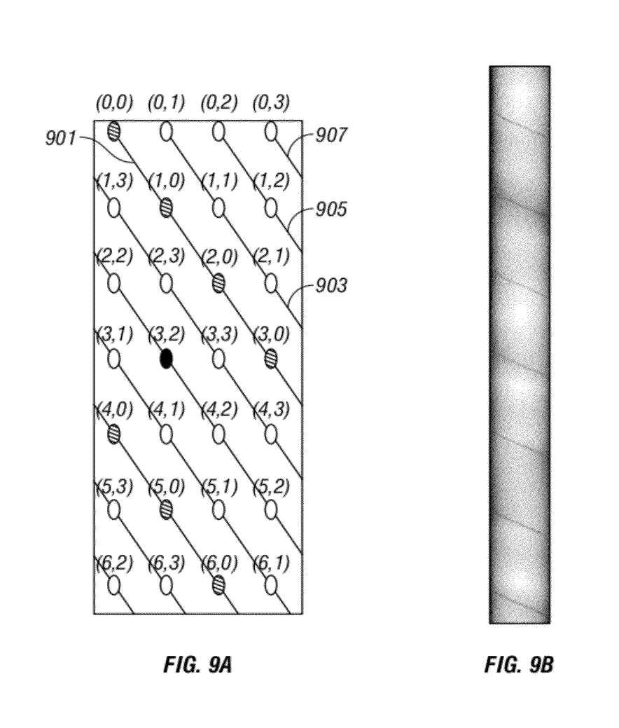

FIGS. 8A and 8B show exemplary strain maps before and after the exemplary grating location correction just described. The strains of FIG. 8A which exhibit a deviation from the vertical are substantially vertical in FIG. 8B after the correction is applied.

In addition to measuring strain, the FBGs are affected by thermal effects and changes in temperature which cause expansion or contraction of the FBG. This expansion or contraction causes the FBG to provide a wavelength shift measurement that is unrelated to the strain of the tubular at that particular FBG. An increase in temperature, as is generally seen downhole, always results in a positive wavelength shift in the data, while a positive axial strain can result in either positive or negative shifts in the data, depending on the wrap angle. Therefore, in one aspect, the present disclosure corrects for the effects of temperature on measurements obtained downhole from the FBGs.

Returning to FIG. 1, a distributed temperature sensing (DTS) system is disposed on the tubular 102 to obtain temperature measurements for correcting strain measurements. The exemplary DTS system of FIG. 1 includes a DTS fiber optic cable 122 with DTS sensors 124 spaced apart from each other along the DTS fiber optic cable 122. In one embodiment, a laser light is introduced into the DTS fiber optic cable 122 and Raman scattering occurs at the DTS sensors 124. The Raman scattering typically gives rise to Stokes and anti-Stokes peaks. Typically, the anti-Stokes peak is responsive to a change in temperature while the Stokes peak is not. A comparison of these peaks therefore gives a measurement indicative of temperature change. These temperature measurements from DTS are then used to correct strain measurements at the FBGs.

In order to compensate for the temperature effect on wavelength shift data, an independent temperature measurement such as distributed temperature sensing (DTS) or a Pressure/Temperature (P/T) gauge may be used. In one aspect, a DTS map of temperature is obtained at multiple locations of a tubular. Although DTS measurement may provide a temperature profile along depth domain, temperature gauges may be used alongside the DTS data to provide a correction to temperature data. When used together, the measurements from the temperature gauges and DTS form a linear relationship that may be applied between the differences in temperature (T^{DTS}−T^{R}) and the a depth (Z) of the sensors:

T^{DTS}−T^{R}=AZ+B Eq. (2)

where, T^{DTS} and T^{R} are respectively the DTS and reference temperature (obtained from a temperature gauge), A and B are the slope and the intercept.

Reference temperature gauges are usually placed at the locations different from that of any DTS sensor. Before conducting a temperature correction, DTS data are mapped to a location where the reference sensor resides. Alternatively, the reference data may be mapped to a location where the DTS sensor resides. An insertion algorithm may be used to interpolate the DTS data to where the reference is located.

For a temperature profile (T^{DTS}₁, T_{DTS}₂, T_{DTS}₃, . . . T_{DTS}_{N}) and reference temperature profile (T^{R}₁, T^{R}₂, T^{R}₃, . . . T^{R}_{N}) at the depth positions (Z₁, Z₂, Z₃, . . . Z_{N}), a linear regression method may be used to calculate the values of slope A and intercept B:

Tᵢ^{DTS}−Tᵢ^{R}=AZᵢ+B Eq. (3)

where i=1,2,3, . . . N and N=the number of sensors. Once A and B have been calculated, temperature values at any measurement point j can then be calculated using:

Tⱼ=Tⱼ^{DTS}−AZᵢ+B Eq. (4)

The linear regression may be applied to systems having many reference temperature gauges.

Often, single or dual reference sensors are deployed, leading to separate correction approaches. For a single reference point, A is set to be 0 and B is set to be the difference between DTS data and reference temperature at the same position and the same time. This results in all the DTS temperature curves being shifted by a constant c. If two reference sensors are used, they are typically placed respectively near to the top and bottom of a sensing section. The value of A and B are then calculated using the following formulae:

$$\begin{matrix}A = \frac{( {T}_{{i}_{1}}^{DTS} - {T}_{{i}_{2}}^{DTS} ) - ( {T}_{{i}_{1}}^{R} - {T}_{{i}_{2}}^{R} )}{{Z}_{{i}_{1}} - {Z}_{{i}_{2}}} & Eq . ( 5 ) \\ B = \frac{{Z}_{{i}_{1}} ( {T}_{{i}_{2}}^{DTS} - {T}_{{i}_{2}}^{R} ) - {Z}_{{i}_{2}} ( {T}_{{i}_{1}}^{DTS} - {T}_{{i}_{1}}^{R} )}{{Z}_{{i}_{1}} - {Z}_{{i}_{2}}} & Eq . ( 6 )\end{matrix}$$

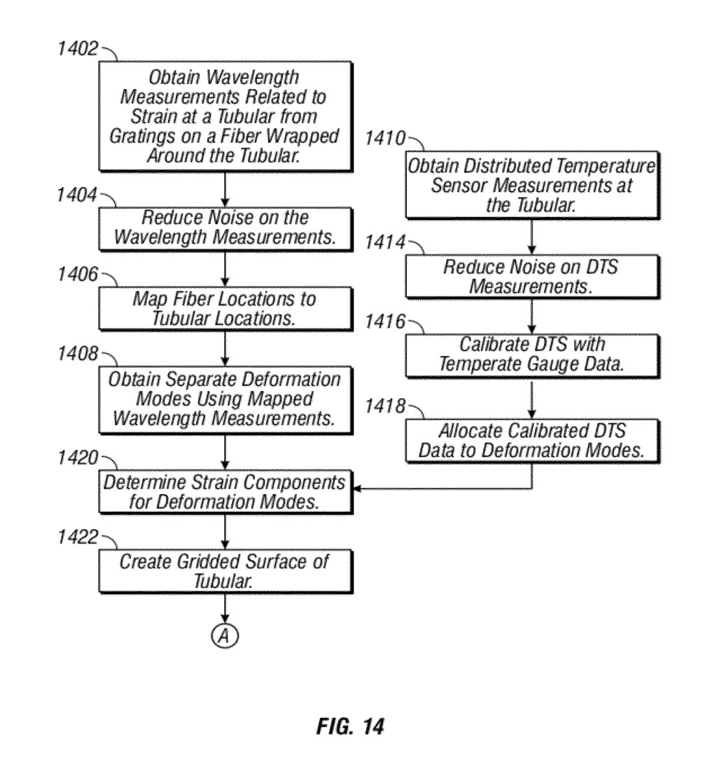

Once DTS data has been obtained and corrected, they are used to correct deformation modes for the thermal effects of downhole temperatures, as shown in the exemplary flowchart of FIG. 13. The deformation modes can then be used to determine a surface map of strain or additionally an image of the strain, including two-dimensional and three-dimensional imaging.

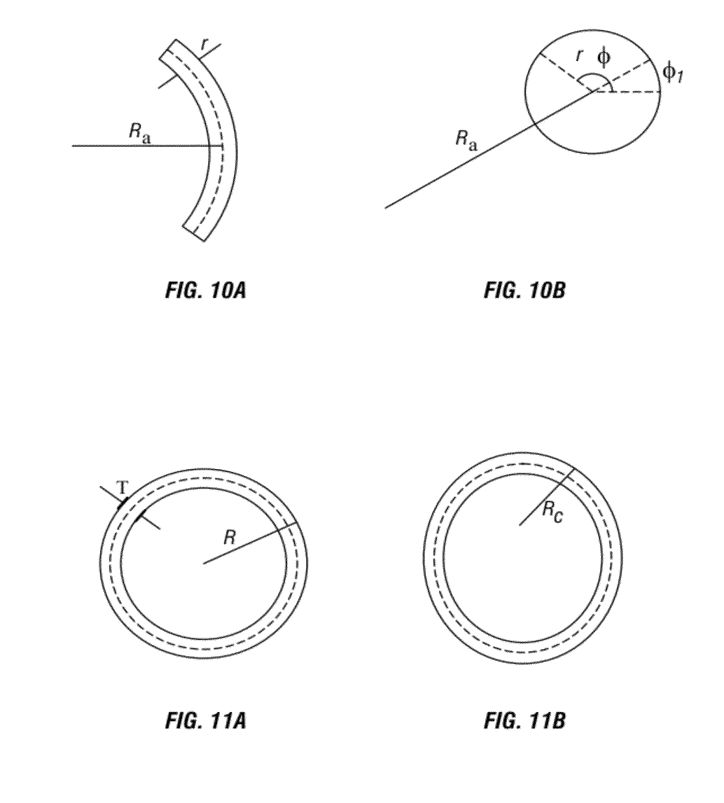

FIG. 9A illustrates an exemplary gridding system for strain interpolation that may be used with a fiber optic cable with optical sensors wrapped along the surface of a tubular. The length of the pipe is indicated along the vertical axis and the circumference is shown along the horizontal axis from 0° to 360°. The first wrapped curve 901 indicates a fiber optic cable. The points on the first wrapped curve 901 indicate the location of the FBGs of the wrapped fiber. These points are referred to as grating points with respect to FIG. 9A. The fiber optic cable wraps around the circumference such that an integral number of grating points are included in a single wrap. An integral number of wrapping curves 903, 905, 907 are then inserted and points on the inserted curves are referred to as gridding points. Each point on the grid is indicated by two indices indicating their position in a two dimension space. The first index indicates a position of the point along a given curve. The second index indicates which wrapping curve the point belongs to. For example, point (2,0) is the second gratin point of curve 901. Grating points 401 typically are identified by having second indices which are equal to zero.

The strain of a gridding point can be calculated from the values of the neighboring grating points by using an exemplary linear interpolation method of Eq. (7).

ε_{i,j}=└jε_{i+j,0}+(N−j)ε_{i+j-N,0}┘/N Eq. (7)

where N is the number of gratings in each wrap. For simplicity, the two nearest grating points in the same column may be used to calculate a strain at a gridding point. Using the example of Eq. (7) to gridding point (3,2) of FIG. 9A, the strain at gridding point (3,2) is given by ε_{3,2}=[ε_{5,0}+ε_{1,0}]/2. In addition to the exemplary interpolation method of Eq. (2), a number of interpolations may be used. FIG. 9B shows a three-dimensional image with surface color representing the interpolated strains on the tubular. The surface color changes from blue to red, corresponding to the change of the surface strains from maximum negative to positive.

Once the deformation modes are separated as described using the exemplary methods described above, they can be separately applied to iterative process that yields in one aspect a geometrical data for the bending mode of the tubular and in another aspect geometrical data for the cross-sectional deformations of the tubular. The obtained geometrical data can be used to obtain a three-dimensional image of the tubular which can be useful in determining a wear or condition of the tubular.

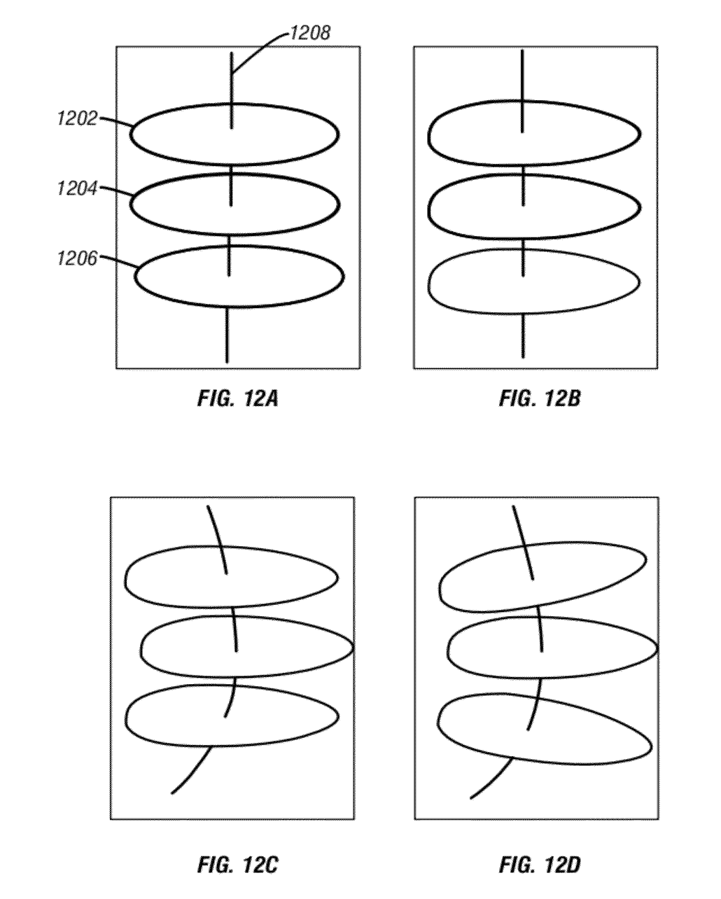

A method of determining geometrical data for the bending deformation is now discussed. FIG. 10A shows a side view of an exemplary tubular undergoing a bending force. The tubular has a radius r and a bending radius of curvature Rₐ. Over a sufficiently short section of a tubular, the length of the neutral (strain-free) axis of the tubular remains constant during the bending process. FIG. 10B shows a top view cross-section of the tubular of FIG. 10A. The radius of curvature Rₐ, the radius of the tubular r, the azimuthal position coordinate of the tubular φ and the bending azimuth angle Φ₁ are shown. The two deformation parameters (the radius of curvature Rₐ and the bending azimuth angle φ₁) describe the magnitude and the direction of the bending and are related to the bending strain through:

$${ɛ}_{b} = \frac{r}{{R}_{a}} cos ( φ - {φ}_{1} ) \qquad Eq . ( 8 )$$

where r and φ are position coordinates of the tubular and φ₁ is the bending azimuthal angle. Thus the bending strain such as obtained in FIG. 4 may be selected at each point to determine Rₐ and φ₁ at a selected point on the tubular.

An exemplary numerical process for obtaining geometrical data from the deformation parameters Rₐ and φ₁ is now discussed. In the numerical process, bending strain can be represented by a two-dimensional vector \vec{e}_{b} lying within a cross-section perpendicular to the axis of the tubular such as the cross-section of FIG. 10B. The bending strain can be decomposed into two components that point respectively to the x and y direction, wherein x and y directions are defined to be in the cross-sectional plane:

\vec{ε}_{b}=\vec{ε}_{bx}+\vec{ε}_{by} Eq. (9)

with

$${\vec{ɛ}}_{bx} = \frac{x}{{R}_{x}} {i}^{⋒} and {\vec{ɛ}}_{by} = \frac{y}{{R}_{y}} \hat{j} \qquad Eqs . ( 10 )$$

Eqs. (8)-(10) can be combined to obtain the following equations:

$${ɛ}_{bx} = {ɛ}_{b} cos φ - \frac{\partial {ɛ}_{b}}{\partial φ} sin φ \\ {ɛ}_{by} = {ɛ}_{b} sin φ + \frac{\partial {ɛ}_{b}}{\partial φ} cos φ \\ {R}_{a} = \frac{r}{\sqrt{{ɛ}_{b} + {( \frac{\partial {ɛ}_{b}}{\partial φ} )}^{2}}} \qquad Eqs . ( 11 )$$

Various methods are known for calculating

$$\frac{\partial {ɛ}_{b}}{\partial φ} ,$$

the first derivative of the bending strain with respect to the azimuthal angle. From Eq. (12), once ε_{b} and

$$\frac{\partial {ɛ}_{b}}{\partial φ}$$

are known, the values of the strain components \vec{e}_{bx} and \vec{ε}_{by} can then be calculated. The bending parameters Rₓ and R_{y}, which are x and y components of Rₐ, may then be calculated from Eq. (10) and (11). Rₓ and R_{y} are related to the axial bending variable by:

$${R}_{x} = \frac{{( 1 + {z}_{x}^{′2} )}^{3 / 2}}{{z}_{xx}^{″}} \\ {R}_{y} = \frac{{( 1 + {z}_{y}^{′2} )}^{3 / 2}}{{z}_{yy}^{″}} \qquad Eqs . ( 12 )$$

where z is the axial coordinate of the tubular. Once Rₓ and R_{y} are known, one can numerically solve Eqs. (12) to obtain geometrical data for bending.

In one aspect, the axial bending deformation can be calculated by numerically solving the Eqs. (12) using selected boundary conditions for the tubular. The most commonly applied boundary conditions are:

zₓ′(z=0)=z_{y}′(z=0)=0

x(z=0)=x(z=1)=0

y(z=0)=y(z=1)=0

where z=0 and z=1 are the z coordinates of the end points of the axis of the tubular. Eqs. (13) holds true if the bending occurs only in the sensing section and the casing is significantly longer than the sensing section. Using the mathematical groundwork of Eqs. (8)-(13), the iterative process for obtaining geometrical data for the bending deformation is discussed below in reference to Eqs. (14)-(18).

Referring to FIG. 1, each grating of the fiber optic cable is assigned a grating number i=1 to N, where N is the total number of gratings. The position of the grating i, its position is a function of its wrapping angle and can be written in the coordinates x(i), y(i), z(i) with first derivatives given by x_{z}′(i) and y_{z}′(i). The first derivative for the i+1^{th} grating can be calculated from the coordinates and derivatives of the i^{th} grating using Eqs. (14):

$${x}_{z}^{′} ( i + 1 ) = {x}_{z}^{′} ( i ) + \frac{{( 1 + {{x}_{z}^{′} ( i )}^{2} )}^{3 / 2}}{{R}_{x}} * dz \\ {y}_{z}^{′} ( i + 1 ) = {y}_{z}^{′} ( i ) + \frac{{( 1 + {{y}_{z}^{′} ( i )}^{2} )}^{3 / 2}}{{R}_{y}} * dz \qquad Eqs . ( 14 )$$

with

dz=d*sin θ Eq. (15)

wherein d is the spacing between gratings and 8 is the wrapping angle of the fiber optic cable. The position of the i+1^{th} grating is therefore determined by:

x(i+1)=x(i)+x′_{z}(i+1)*dz

y(i+1)=y(i)+y′_{z}(i+1)*dz Eqs. (16)

Thus, in one aspect, the numerical solution begins with a first point such as x(0), y(0), z(0), in which its position and first derivatives are known from the boundary conditions and uses Eqs. (14)-(16) to obtain x(N), y(N), z(N) through N iterations. The coordinates of the Nth grating is compared with the boundary conditions. If the difference between them is greater than a selected criterion, the initial guess on the boundary condition derivatives of the first point is modified using Eqs. (17):

x′_{z}(0)=x′_{z}(0)+(x(N)−x_{N})*2/N

y′_{z}(0)=y′_{z}(0)+(y(N)−y_{N})*2/N Eqs. (17)

where (x_{N}, y_{N}) is the position of the last point as given by the boundary conditions and (x(N), y(N)) is the position of the N^{th} grating from the numerical process. The numerical process is then repeated until the difference between the calculated position and the position given in the boundary conditions for the N^{th} grating is within a preselected criterion, such as the criterion of Eqs. (18):

|x(N)−x_{N}|<σ_{allowed}

|y(N)−y_{N}|<σ_{allowed}

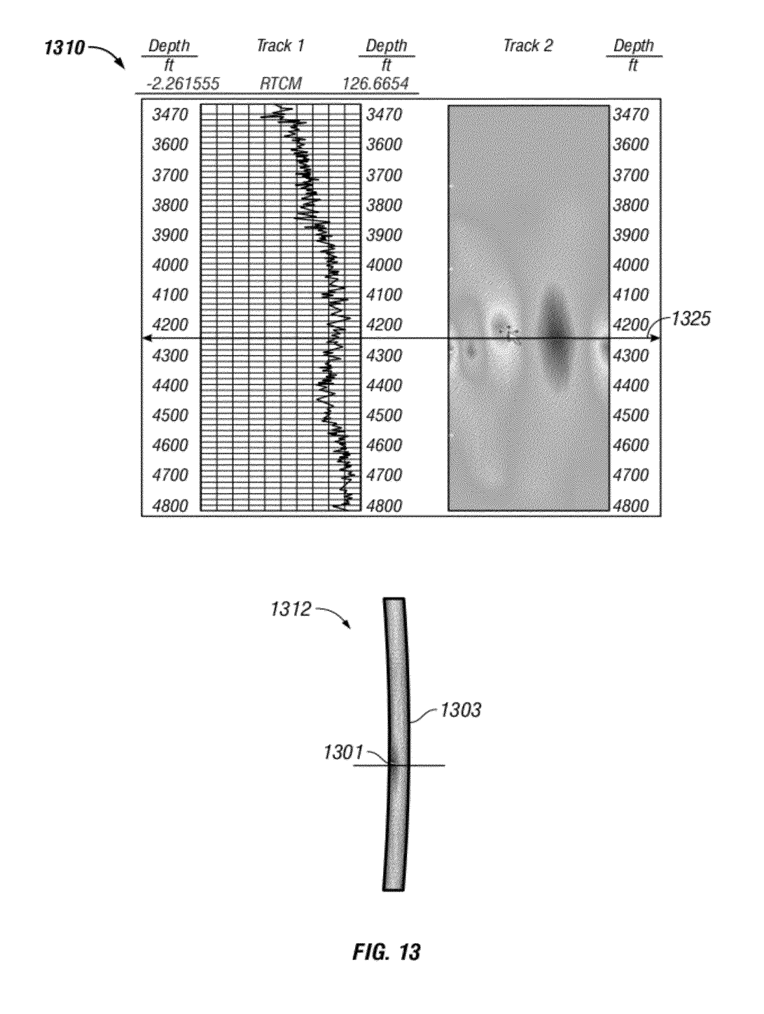

The geometrical information for the bending deformation is obtained once the criteria of Eqs. (18) are met. An exemplary method for obtaining geometrical information from cross-sectional deformation parameters is now discussed with respect to FIGS. 11A-B.

FIGS. 11A and 11B shows a radius of curvature R_{c} related to cross-sectional deformations generically describes a deformation caused by all of the cross-sectional deformation modes. Eq. (19) correlates the corresponding strain data to the deformation parameter R_{c}:

$${R}_{c} = \frac{1 + {ɛ}_{( O , T , C )}}{1 + 2 {ɛ}_{( O , T , C )} r / T} r \qquad Eq . ( 19 )$$

where ε(O,T,C) denotes a summation of all the three strain components (ovalization, triangularization, rectangularization), r is the original (undeformed) radius of the tubular and T is the thickness of the wall of the tubular. As long as enough data points are available, one can determine the shape of a closed curve of fixed length that represents the contour of the cross-section from the radius of curvature in two-dimensional space. Typically, polar coordinates are used in this process. In a polar coordinate system, for any curve in 2D space, the radius of the curvature can be calculated as:

$${R}_{c} = \frac{{( 1 + {u}_{θ}^{′} )}^{3 / 2}}{1 + {u}_{θ}^{′} - {u}_{θ θ}^{″}} r \qquad Eq . ( 20 )$$

where u′_{θ} and u″_{θθ} are respectively the first and second derivative of the logarithm of r over the azimuth angle (u=ln r). Within a limited degree of deformation, u′_{θ} is much less than 1. Therefore, Eq. (20) may be further simplified to:

$${R}_{c} = \frac{1 + \frac{3}{2} {u}_{θ}^{′}}{1 + {u}_{θ}^{′} - {u}_{θ θ}^{″}} r \qquad Eq . ( 21 )$$

which can be rewritten in the form of a normal differential equation as:

R_{c}u_{θθ}″+(3/2r−R_{c})u_{θ}′+(r−R_{c})=0 Eq. (22)

The boundary conditions for Eq. (22) are:

r(θ=0)=r(θ=2π)

r_{θ}′(θ=0)=r_{θ}′(θ=2π) Eqs. (23)

Using the Eqs. (22) and (23), a contour of a particular cross-section of the tubular can be created. The N gratings may be used to calculate position coordinates along the contour, with index i=1 to N. In one aspect, the position coordinates and derivates of the first grating is obtained. Given the position r(i) and the first derivative r′(i) of a point i in the cross-section, the first derivative r′_{θ}(i+1) of the adjacent point i+1 is calculated using Eq. (24):

$${r}_{θ}^{′} ( i + 1 ) = {r}_{θ}^{′} ( i ) + [ ( 1 - \frac{3 r ( i )}{2 {R}_{c}} ) {r}_{θ}^{′} ( i ) + ( 1 - \frac{r ( i )}{{R}_{c}} ) {r}_{θ} ( i ) ] * \frac{2 π}{N} \qquad Eq . ( 24 )$$

The position r(i+1) can then be calculated as

$$r ( i + 1 ) = r ( i ) + {r}_{θ}^{′} ( i + 1 ) * \frac{2 π}{N} \qquad Eq . ( 25 )$$

Thus each point is used to calculate values for the next point along the circumference. For a given cross-section, the boundary values for the first point can be taken from the endpoint values obtained from the previously calculated cross-section. An educated estimate can be used as initial boundary values for the first cross-section. The values obtained for the N^{th} point are checked against a suitable criterion such as the criterion of Eq. (26):

[r(N)ₚᵣₑᵥᵢₒᵤₛ−r(N)_{current}]²+[r′_{θ}(N)ₚᵣₑᵥᵢₒᵤₛ−r′_{θ}(N)_{current}]²<σ (26)

where σ is a present tolerance for the combined square error between two iterations. In a typical calculation, σ may be set to 0.0001.

Thus, calculations described using the Eqs. (8)-(26) yield geometrical information for the bending deformations and for cross-sectional deformations. The obtained geometrical information can then be used to obtain a three-dimensional image of the tubular using exemplary methods discussed below.

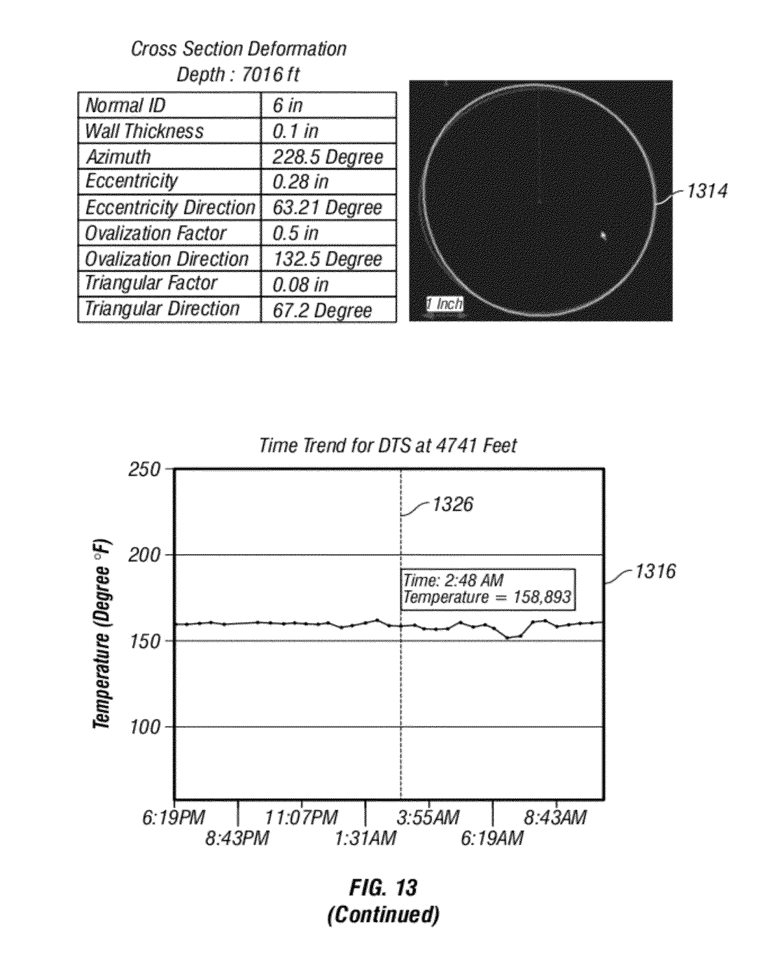

In one aspect, the exemplary method of creating a 3D image includes introduces an unstressed tubular having an axis, applying the geometrical information of the bending parameter to the axis to obtain a bent axis, applying the geometrical information of the cross-sectional deformations and adjusting the orientation of the cross-sections to correspond with the orientation bent axis. In one aspect, the three-dimensional image may be sent to a display and a stresses on the tubular shown. The various step of the exemplary method are discussed below in reference to FIGS. 12A-D.

FIG. 12A shows an exemplary original construction of an image of a tubular. The construct includes three surfaces 1202, 1204 and 1206 aligned along tubular axis 1108, which is oriented along a z-axis for the sake of illustration. The 3D surface image may be constructed using a suitable gridding technique and a set of initial geometrical data. In one embodiment, the cross-sections are centered with the bent axis after the cross-section deformations have been applied to the contours of the cross-sections. FIG. 12B shows the tubular of FIG. 12A after a radial deformation is applied to each cross section. While bending the tubular axis, each cross-section is kept within the plane in which it resides before the bending. Due to the separation of deformation modes, the length of the circumference of the pipe remains unchanged during a cross-sectional deformation and only the shape of the cross-section is affected. The cross-sections then are moved parallel to the xy-plane so that their centers correspond to the bent axis as shown in Eq. (27):

$$( \begin{matrix}{x}^{′} \\ {y}^{′} \\ {z}^{′}\end{matrix} ) = ( \begin{matrix}1 & 0 & 0 \\ 0 & 1 & 0 \\ 0 & 0 & 1\end{matrix} ) ( \begin{matrix}x \\ y \\ z\end{matrix} ) + ( \begin{matrix}Δ x \\ Δ y \\ Δ z\end{matrix} ) \qquad Eq . ( 27 )$$

wherein (x, y, z) and (x′, y′, z′) are respectively the coordinates of a surface point in the cross-section before and after the bending and (Δx, Δy, Δz) is the motion caused by the bending of the cross point between the plane and the axis. FIG. 12C shows an exemplary tubular with bent axis and maintaining cross-sections within the xy-plane.

Once the cross-sections are centered on the bent axis, they are reoriented to reflect the bent axis using the exemplary methods discussed below. A tangent line to the bending axis is calculated, which is given in Eq. (28):

\vec{l}=(xᵢ₊₁−xᵢ)\vec{i}+(yᵢ₊₁−yᵢ)\vec{j}+(zᵢ₊₁−zᵢ)\vec{k} Eq. (28)

wherein (xᵢ₊₁, yᵢ₊₁, zᵢ₊₁) and (xᵢ, yᵢ, zᵢ) are coordinates of two closest neighboring points along the bending axis. In one embodiment, the cross-sections are reoriented using a spherical coordinate system for spatial transformation. Eq. (28) can be rewritten in spherical coordinates as:

\vec{l}=r cos θ cos φ·\vec{i}+r cos θ sin φ·\vec{j}+sin φ·\vec{k} Eq. (29)

where

r=\sqrt{(xᵢ₊₁−xᵢ)²+(yᵢ₊₁−yᵢ)²+(zᵢ₊₁−zᵢ)²}

cos θ=(zᵢ₊₁−zᵢ)/r

sin θ=(xᵢ₊₁−xᵢ)/r cos Eq. (30)

where θ is an azimuth angle around the y-axis and φ is an elevation angle. In a spherical coordinate system, to reorient the cross-sections, one sets the original point in the cross between the axis and the cross-section, and the directions of the axis to be parallel to the current coordination system. The rotated coordinate system is achieved by rotating each cross-section by an azimuth angle (θ) around the y-axis and an elevation angle (φ), and then rotating an elevation angle (φ) around the z-axis using:

$$( \begin{matrix}{x}^{′} \\ {y}^{′} \\ {z}^{′}\end{matrix} ) = ( \begin{matrix}cos φ & sin φ & 0 \\ - sin φ & cos φ & 0 \\ 0 & 0 & 1\end{matrix} ) ( \begin{matrix}- cos θ cos φ & cos θ sin φ & sin θ \\ sin φ & cos φ & 0 \\ - sin θ sin φ & sin θ sin φ & - cos θ\end{matrix} ) ( \begin{matrix}x \\ y \\ z\end{matrix} ) \qquad Eq . ( 31 )$$

FIG. 13 shows a multi-dimensional display of a tubular strain map corresponding to wavelength shift measurements. The display includes a log 1310 of strain measurements such as are related to measurements obtained using the FBGs 106 of FIG. 1 and a two-dimensional map corresponding to the strain measurements that includes a color map indicating strain. The display also includes a three-dimensional map 1312 of the tubular that includes a color map indicating strain. The exemplary three-dimensional image of a tubular is generated using the exemplary methods discussed with respect to FIGS. 12A-D. Area 1301 indicates an area of an accumulation of negative strain and the area 1303 on the opposite side indicates an area of an accumulation of positive strain. The three-dimensional image presents visual information on where the deformation occurs and enables an operation to determine the severity of the deformation and a likelihood of tubular failure.

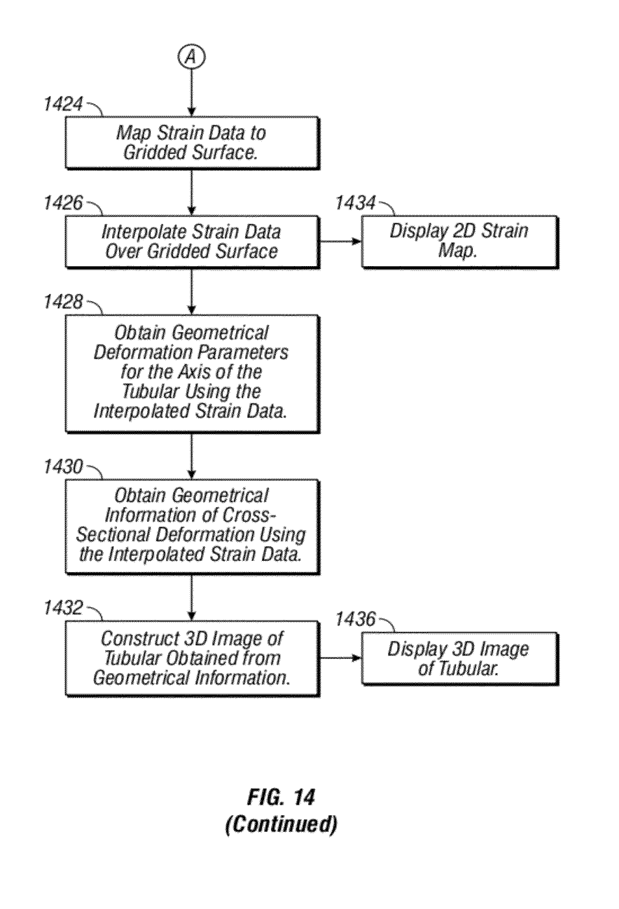

Also shown in FIG. 13 are a view of a cross-sectional deformation 1314 of the tubular at a selected point and a time trend plot 1316 indicated DTS measurements over time. Marker line 1325 enables an operator to select a cross-section of the tubular by selecting the position of the marker line in strain maps 1310 and 1312. In addition, marker line 1326 may be adjusted by an operator to select images 1310, 1312 and 1314 at a selected time. 2D and 3D views 1310 and 1312 may include zoom-in and zoom-out scaling features as well as view rotation features. A movie display may be used to animate the changes in all views. The various exemplary methods described herein for obtaining the exemplary display of FIG. 13 are discussed with respect to FIG. 14.

FIG. 14 shows a flowchart of an exemplary method of the disclosure for obtaining an image of a deformation of a tubular. In Box 1401, data such as wavelength shift data is obtained from fiber optic gratings in a fiber optic cable wrapped around the tubular. In Box 1402, the wavelength is filtered in order to reduce noise in the wavelength shift signals. In Box 1404, the fiber locations are mapped to locations on the tubular. In Box 1408, the wavelength data is used to obtain separate deformation modes.

Alongside the wavelength measurements, In Box 1410, distributed temperature sensors (DTS) measurements are obtained at the tubular. In Box 1412, the DTS measurements are filtered to reduce noise on the DTS signal. In Box 1414, the filtered DTS measurements are calibrated with temperatures obtained using independent temperature gauges. In Box 1416, the calibrated DTS data is allocated to deformation modes. These allocated DTS data and the deformation modes are used to determine strain components for each deformation mode in Box 1420.

Once the strain components have been determined, they may be used to create an image map of the stain. In Box 1424, a gridded surface of the tubular is created. In Box 1424, the obtained strain data is mapped to the gridded surface. In Box 1226, an interpolation method is applied to the mapped strain data to obtain strains at non-grating locations of the tubular. This surface may be sent to a display as in Box 1434 and as shown in the exemplary FIG. 9B. In Box 1428, geometrical deformation parameter for the axis of a tubular for the gridded surface using the interpolated strain data. In Box 1430, geometrical deformation parameters for cross-sectional deformations are obtained using the interpolated strain data. In Box 1432, the geometrical information is used to construction a three-dimensional image of the tubular. This 3D image may be displayed for example in Box 1436.

Therefore, in one aspect, the present disclosure provides a determining an effect of an event on a parameter of a member, the method including: obtaining a plurality of strain measurements at a plurality of times, each strain measurement corresponding to a sensor located at the member; applying a temperature correction to the plurality of strain measurements obtained at each of the plurality of times; obtaining the parameter from the plurality of temperature-corrected strain measurements at each of the plurality of times; and determining the effect of the event on the parameter from the time-correlated parameters. The member may be a casing, a sand screen, a subsea riser, an umbilical, a tubing, a pipeline, a cylindrical structure bearing a load, or a cylindrical structure under thermal dynamic changes. The parameter may include temperature, strain, pressure, a structural deformation parameter of the member, or a distributed parameter that can be interpreted from the strain distribution. The system configuration parameter may be at least one of: (1) a spatial location of the member in a wellbore; and (2) a strain sensor location on the member; (3) a spatial distance from a strain sensor to a sensing point of a temperature measurement; (4) the distance from a location of a temperature measurement to a location of a pressure/temperature gauge; (5) a geometry parameter of the member; and (6) a physical property of the member. The geometry parameter of the member may be at least one of: (1) strain string helical wrap angle; (2) tubular radius; (3) tubular wall thickness; (4) fiber capillary diameter; (5) capillary wall thickness; (6) the distance between first strain sensor to the second strain sensor; (7) groove depth; and (8) fiber string attach scheme. The method of claim 4, wherein the physical property of the member may include Poisson's ratio, a temperature strain factor, refractive index strain effect, or bounding coefficient. In one embodiment, obtaining the system configuration parameter further includes obtaining a deflection strain data of a member in a controlled environment and determining the system configuration from the deflection data. A member baseline waveform signature may be constructed from the defection strain data. System configuration parameters may be stored to a data structure. In another aspect, the exemplary method may include obtaining a first dataset of wavelength shift related to a strain at each sensor of a plurality of sensors located on the member; removing noise from the first data set; extracting a second dataset from the first dataset that corresponds to a selected deformation mode; and providing an image of strain on the member for the selected deformation mode using the second dataset. In addition, the temperature correction may be applied by obtaining a distributed temperature measurement at a plurality of positions at the member; removing noise from the distributed temperature measurement; obtaining a pressure/temperature measurement from a gauge located at the member; and applying a correction to the distributed temperature measurements using the obtained pressure/temperature measurement. In another aspect, the method may include creating a grid on the surface of the member; mapping the plurality of strain measurement to the grid; obtaining an interpolated set of strain measurements from the mapped strain measurements; and determining a deformation parameter of the member using the interpolated set of measurements. Determining the deformation parameter of the member may further include obtaining geometrical deformation parameters for an axis of the member using the obtained interpolated set of strain measurements, and obtaining geometrical deformation parameters for a cross section of the member using the interpolated set of strain measurements. In yet another aspect, the method includes obtaining a log track image correlating the parameter with a wellbore structure and the event; determining a work-over pass-through radius for given depth range; and obtaining a time trend diagram correlating the parameter with the event. The log track image may be at least one of: (1) a 2D color map of the parameter; (2) a 3D image of the member with a surface color map of the parameter; (3) a 3D bending axial image; and (4) one or more log charts of the parameter. Determining the work-over pass-through radius may include obtaining multiple cross section contours of the member for a given depth range, and determining the work-over pass-through radius from the multiple cross section contours.

In another aspect, the present disclosure provides an apparatus for determining an effect of an event on a parameter of a member, the apparatus including a plurality of sensors located at the member; a device configured to obtain a plurality of strain measurements from the plurality of sensors at a plurality of times, wherein each strain measurement corresponding to a sensor from the plurality of sensors; and a processor configured to: apply a temperature correction to the plurality of strain measurements obtained at each of the plurality of times, obtain the parameter from the plurality of temperature-corrected strain measurements at each of the plurality of times, and determine the effect of the event on the parameter from the time-correlated parameters. The member may be a casing, a sand screen, a subsea riser, an umbilical, a tubing, a pipeline, a cylindrical structure bearing a load, or a cylindrical structure under thermal dynamic changes. The parameter may include temperature, strain, pressure, a structural deformation parameter of the member, or a distributed parameter that can be interpreted from the strain distribution. The system configuration parameter may be at least one of: (1) a spatial location of the member in a wellbore; and (2) a strain sensor location on the member; (3) a spatial distance from a strain sensor to a sensing point of a temperature measurement; (4) the distance from a location of a temperature measurement to a location of a pressure/temperature gauge; (5) a geometry parameter of the member; and (6) a physical property of the member. The geometry parameter of the member may be at least one of: (1) strain string helical wrap angle; (2) tubular radius; (3) tubular wall thickness; (4) fiber capillary diameter; (5) capillary wall thickness; (6) the distance between first strain sensor to the second strain sensor; (7) groove depth; and (8) fiber string attach scheme. The method of claim 4, wherein the physical property of the member may include Poisson's ratio, a temperature strain factor, refractive index strain effect, or bounding coefficient. The processor may be configured to obtain a deflection strain data of a member in a controlled environment and determine the system configuration from the deflection data as well as to construct a member baseline waveform signature from the defection strain data. A database may be used to store the system configuration parameters. In one aspect, the processor is configured to obtain a first dataset of wavelength shift related to a strain at each sensor of a plurality of sensors located on the member; remove noise from the first data set; extract a second dataset from the first dataset that corresponds to a selected deformation mode; and provide an image of strain on the member for the selected deformation mode using the second dataset. In another aspect, the processor is further configured to: obtain a distributed temperature measurement at a plurality of positions at the member; remove noise from the distributed temperature measurement; obtain a pressure/temperature measurement from a gauge located at the member; and apply a correction to the distributed temperature measurements using the obtained pressure/temperature measurement. The processor may also be configured to: create a grid on the surface of the member; map the plurality of strain measurement to the grid; obtain an interpolated set of strain measurements from the mapped strain measurements; and determine a deformation parameter of the member using the interpolated set of measurements. In another aspect, the processor is configured to: obtain geometrical deformation parameters for an axis of the member using the obtained interpolated set of strain measurements; and obtain geometrical deformation parameters for a cross section of the member using the interpolated set of strain measurements. The processor may be further configured to: obtain a log track image correlating the parameter with a wellbore structure and the event; determine a work-over pass-through radius for given depth range; and obtain a time trend diagram correlating the parameter with the event. The log track image may include at least one of: (1) a 2D color map of the parameter; (2) a 3D image of the member with a surface color map of the parameter; (3) a 3D bending axial image; and (4) one or more log charts of the parameter. The processor may also be configured to obtain multiple cross section contours of the member for a given depth range, and determine the work-over pass-through radius from the multiple cross section contours.

In another aspect, the present disclosure provides a computer-readable medium having instructions thereon which when read by a processor enable the processor to perform a method, the method including obtaining a plurality of strain measurements at a plurality of times, each strain measurement corresponding to a sensor located at the member; applying a temperature correction to the plurality of strain measurements obtained at each of the plurality of times; obtaining a parameter from the plurality of temperature-corrected strain measurements at each of the plurality of times; and determining an effect of an event on the parameter from the time-correlated parameters.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of determining an effect of an event on a parameter of a member, comprising:
obtaining a plurality of strain measurements at a plurality of times, each strain measurement corresponding to a sensor located at the member;
applying a temperature correction to the plurality of strain measurements obtained at each of the plurality of times;
determining the parameter from the plurality of temperature-corrected strain measurements at each of the plurality of times; and
determining the effect of the event on the parameter from the time-correlated parameters.

2. The method of claim 1, wherein the member is one of: (1) a casing; (2) a sand screen; (3) a subsea riser; (4) an umbilical; (5) a tubing; (6) a pipeline; (7) a cylindrical structure bearing a load; and (8) a cylindrical structure under thermal dynamic changes.

3. The method of claim 1, wherein the parameter is one of: (1) temperature; (2) strain; (3) pressure; (4) a structural deformation parameter of the member; and (5) a distributed parameter that can be interpreted from the strain distribution.

4. The method of claim 1, further comprising obtaining a system configuration parameter that is at least one of: (1) a spatial location of the member in a wellbore; and
(2) a strain sensor location on the member; (3) a spatial distance from a strain sensor to a sensing point of a temperature measurement; (4) the distance from a location of a temperature measurement to a location of a pressure/temperature gauge; (5) a geometry parameter of the member; and (6) a physical property of the member.

5. The method of claim 4, wherein the geometry parameter of the member is one of: (1) strain string helical wrap angle; (2) tubular radius; (3) tubular wall thickness; (4) fiber capillary diameter; (5) capillary wall thickness; (6) the distance between first strain sensor to the second strain sensor; (7) groove depth; and (8) fiber string attach scheme. The method of claim 4, wherein the physical property of the member is one of: (1) Poisson's ratio; (2) temperature strain factor; (3) refractive index strain effect; and (4) bounding coefficient.

7. The method of claim 4, wherein obtaining the system configuration parameter further comprises:
obtaining a deflection strain data of a member in a controlled environment;
determining the system configuration from the deflection data.

8. The method of claim 7, further comprising constructing a member baseline waveform signature from the defection strain data.

9. The method of claim 4, further comprising storing the system configuration parameters to a data structure.

10. The method of claim 1, further comprising:
obtaining a first dataset of wavelength shift related to a strain at each sensor of a plurality of sensors located on the member;
removing noise from the first data set;
extracting a second dataset from the first dataset that corresponds to a selected deformation mode; and
providing an image of strain on the member for the selected deformation mode using the second dataset.

11. The method of claim 1, wherein applying the temperature correction further comprises:
obtaining a distributed temperature measurement at a plurality of positions at the member;
removing noise from the distributed temperature measurement;
obtaining a pressure/temperature measurement from a gauge located at the member; and
applying a correction to the distributed temperature measurements using the obtained pressure/temperature measurement.

12. The method of claim 1, further comprising:
creating a grid on the surface of the member;
mapping the plurality of strain measurement to the grid;
obtaining an interpolated set of strain measurements from the mapped strain measurements; and
determining a deformation parameter of the member using the interpolated set of measurements.

13. The method of claim 12, wherein determining the deformation parameter of the member further comprises:
obtaining geometrical deformation parameters for an axis of the member using the obtained interpolated set of strain measurements; and
obtaining geometrical deformation parameters for a cross section of the member using the interpolated set of strain measurements.

14. The method of claim 1, further comprising:
obtaining a log track image correlating the parameter with a wellbore structure and the event;
determining a work-over pass-through radius for given depth range; and
obtaining a time trend diagram correlating the parameter with the event.

15. The method of claim 14, wherein the log track image is one of: (1) a 2D color map of the parameter; (2) a 3D image of the member with a surface color map of the parameter; (3) a 3D bending axial image; and (4) one or more log charts of the parameter.

16. The method of claim 14, wherein determining the work-over pass-through radius further comprises:
obtaining multiple cross section contours of the member for a given depth range; and
determining the work-over pass-through radius from the multiple cross section contours.

17. An apparatus for determining and effect of an event on a parameter of a member, comprising:
a plurality of sensors located at the member;
a device configured to obtain a plurality of strain measurements from the plurality of sensors at a plurality of times, wherein each strain measurement corresponding to a sensor from the plurality of sensors;
a processor configured to:
apply a temperature correction to the plurality of strain measurements obtained at each of the plurality of times,
determine the parameter from the plurality of temperature-corrected strain measurements at each of the plurality of times, and
determine the effect of the event on the parameter from the time-correlated parameters.

18. The apparatus of claim 17, wherein the member is one of: (1) a casing; (2) a sand screen; (3) a subsea riser; (4) an umbilical; (5) a tubing; (6) a pipeline; (7) a cylindrical structure bearing a load; and (8) a cylindrical structure under thermal dynamic changes.

19. The apparatus of claim 17, wherein the parameter is one of: (1) temperature; (2) strain; (3) pressure; (4) a structural deformation parameter of the member; and (5) a distributed parameter that can be interpreted from the strain distribution.

20. The apparatus of claim 17, wherein the processor is further configured to obtain a system configuration parameter that is at least one of: (1) a spatial location of the member in a wellbore; and (2) a strain sensor location on the member; (3) a spatial distance from a strain sensor to a sensing point of a temperature measurement; (4) the distance from a location of a temperature measurement to a location of a pressure/temperature gauge; (5) a geometry parameter of the member; and (6) a physical property of the member.

21. The apparatus of claim 20, wherein the geometry parameter of the member is one of: (1) strain string helical wrap angle; (2) tubular radius; (3) tubular wall thickness; (4) fiber capillary diameter; (5) capillary wall thickness; (6) the distance between first strain sensor to the second strain sensor; (7) groove depth; and (8) fiber string attach scheme.

22. The apparatus of claim 20, wherein the physical property of the member is one of: (1) Poisson's ratio; (2) temperature strain factor; (3) refractive index strain effect; and (4) bounding coefficient.

23. The apparatus of claim 20, wherein the processor is further configured to obtain a deflection strain data of a member in a controlled environment and determine the system configuration from the deflection data.

24. The apparatus of claim 23, wherein the processor is further configured to construct a member baseline waveform signature from the defection strain data.

25. The apparatus of claim 20, further comprising a database configured to store the system configuration parameters.

26. The apparatus of claim 20, wherein the processor is further configured to:
obtain a first dataset of wavelength shift related to a strain at each sensor of a plurality of sensors located on the member;
remove noise from the first data set;
extract a second dataset from the first dataset that corresponds to a selected deformation mode; and
provide an image of strain on the member for the selected deformation mode using the second dataset.

27. The apparatus of claim 17, wherein the processor is further configured to:
obtain a distributed temperature measurement at a plurality of positions at the member;
remove noise from the distributed temperature measurement;
obtain a pressure/temperature measurement from a gauge located at the member; and
apply a correction to the distributed temperature measurements using the obtained pressure/temperature measurement.

28. The apparatus of claim 17, wherein the processor is further configured to:
create a grid on the surface of the member;
map the plurality of strain measurement to the grid;
obtain an interpolated set of strain measurements from the mapped strain measurements; and
determine a deformation parameter of the member using the interpolated set of measurements.

29. The apparatus of claim 28, wherein the processor is further configured to:
obtain geometrical deformation parameters for an axis of the member using the obtained interpolated set of strain measurements; and
obtain geometrical deformation parameters for a cross section of the member using the interpolated set of strain measurements.

30. The apparatus of claim 20, wherein the processor is further configured to:
obtain a log track image correlating the parameter with a wellbore structure and the event;
determine a work-over pass-through radius for given depth range; and
obtain a time trend diagram correlating the parameter with the event.

31. The apparatus of claim 30, wherein the log track image is one of: (1) a 2D color map of the parameter; (2) a 3D image of the member with a surface color map of the parameter; (3) a 3D bending axial image; and (4) one or more log charts of the parameter.

32. The apparatus of claim 30, wherein the processor is further configured to obtain multiple cross section contours of the member for a given depth range, and determine the work-over pass-through radius from the multiple cross section contours.

33. A computer-readable medium having instructions thereon which when read by a processor enable the processor to perform a method, the method comprising:
obtaining a plurality of strain measurements at a plurality of times, each strain measurement corresponding to a sensor located at the member;
applying a temperature correction to the plurality of strain measurements obtained at each of the plurality of times;
obtaining a parameter from the plurality of temperature-corrected strain measurements at each of the plurality of times; and
determining an effect of an event on the parameter from the time-correlated parameters.
